(19) United States
(12) Patent Application Publication
(10) Pub. No.: US 2024/0212918 A1
(43) Pub. Date: Jun. 27, 2024

(54) COIL COMPONENT

(71) Applicant: SAMSUNG ELECTRO-MECHANICS CO., LTD., Suwon-si (KR)

(72) Inventors: Jin Young Kim, Suwon-si (KR); Ki Young Yoo, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/377,630

(22) Filed: Oct. 6, 2023

(30) Foreign Application Priority Data
Dec. 27, 2022 (KR) 10-2022-0186143

(51) Int. Cl. H01F 27/28; H01F 27/29

(52) U.S. Cl. CPC H01F 27/2828; H01F 27/292

(57) ABSTRACT

A coil component includes: a body; a coil buried in the body; an external electrode disposed on one surface of the body; and a lead-out portion connecting an end of the coil to the external electrode, wherein the lead-out portion and the end of the coil form an interface.

### CROSS-REFERENCE TO RELATED APPLICATION(S)

The present application claims benefit of priority to Korean Patent Application No. 10-2022-0186143, filed on Dec. 27, 2022 in the Korean Intellectual Property Office, the entire disclosure of which is incorporated herein by reference.

### TECHNICAL FIELD

The present disclosure relates to a coil component.

### BACKGROUND

An inductor, a type of coil component, is a representative manual electronic component used in electronic devices, along with a resistor and a capacitor.

As electronic devices become higher in terms of performance and smaller, the number of electronic components used in the electronic device is increasing and the electronic components are becoming smaller.

In particular, with a decrease in the thickness of a coil component, a magnetic substance covering an electrode lead-out portion is becoming insufficient, which may cause the electrode lead-out portion to be frequently broken.

### SUMMARY

An aspect of the present disclosure is to provide a coil component in which a breaking phenomenon of an electrode lead-out portion being broken is improved.

According to an aspect of the present disclosure, disclosed is a coil component including: a body; a coil buried in the body; an external electrode disposed on one surface of the body; and a lead-out portion connecting an end of the coil to the external electrode, wherein the lead-out portion and the end of the coil have an interface formed therebetween.

According to the present disclosure, as the thickness of an electrode portion of a coil component is implemented low, a magnetic substance covering an electrode lead-out portion may be sufficiently ensured, thereby improving a breaking phenomenon of the electrode lead-out portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view schematically illustrating a coil component according to an example embodiment of the present disclosure;

FIG. 2 is a view illustrating a coil component according to an example embodiment of the present disclosure when viewed from above;

FIG. 3 is a view illustrating a cross-section taken along line I-I′ of FIG. 1;

FIG. 4 is a view illustrating a cross-section taken along line II-II′ of FIG. 1;

FIG. 5 is a view illustrating a cross-section taken along line I-I′ corresponding to FIG. 3, as a modified example according to an example embodiment of the present disclosure; and

FIG. 6 is a view illustrating a cross-section taken along line II-II′ corresponding to FIG. 4, as a modified example according to an example embodiment of the present disclosure.

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, components and/or combinations thereof, but do not preclude the presence or addition of one or more other features, integers, steps, operations, elements, components, and/or groups thereof. Furthermore, throughout the specification, the term “on” means positioning above or below the object portion, but does not essentially mean positioning on the upper side of the object portion based on a gravity-direction.

The term “coupled to,” “combined to,” and the like, may not only indicate that elements are directly and physically in contact with each other, but also include the configuration in which the other element is interposed between the elements such that the elements are also in contact with the other component.

In the drawings, sizes and thicknesses of elements illustrated in the drawings are indicated as examples for ease of description, and example embodiments in the present disclosure are not limited thereto.

In the drawings, an X-direction may be defined as a first direction or an L direction, a Y-direction may be a second direction or a W direction, and a Z-direction may be a third direction or a T direction.

In the descriptions described with reference to the accompanied drawings, the same elements or elements corresponding to each other will be described using the same reference numerals, and overlapping descriptions will not be repeated.

In electronic devices, various types of electronic components may be used, and various types of coil components may be used between the electronic components to remove noise, or for other purposes.

In other words, in electronic devices, a coil component may be used as a power inductor, a high frequency (HF) inductor, a general bead, a GHz bead, a common mode filter, and the like.

### First Example Embodiment

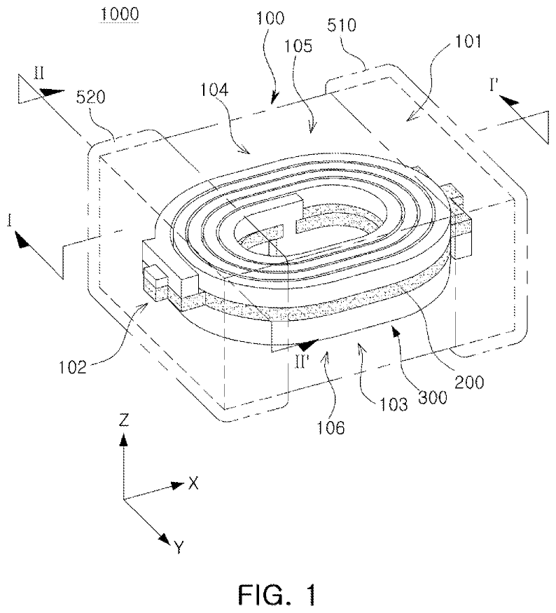

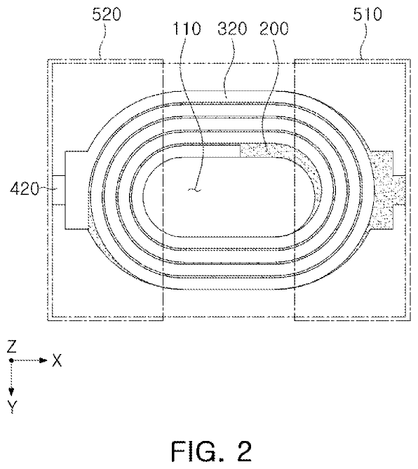

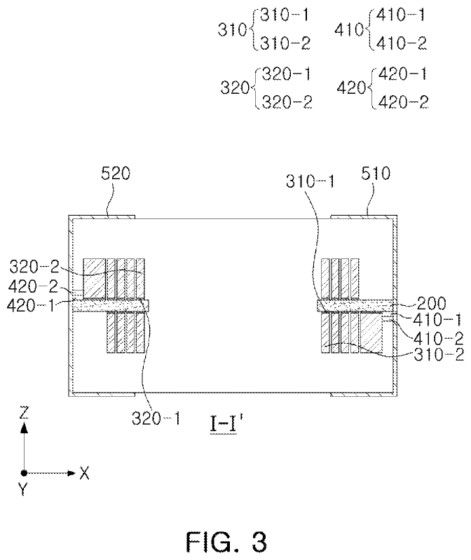

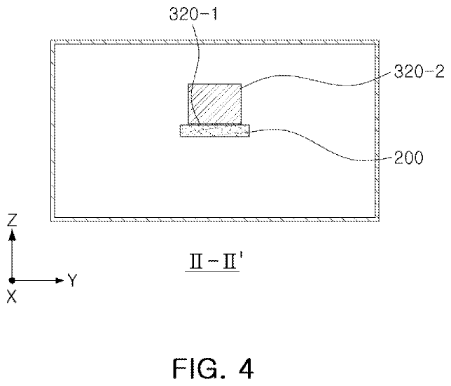

FIG. 1 is a view schematically illustrating a coil component according to an example embodiment of the present disclosure. FIG. 2 is a view illustrating a coil component according to an example embodiment of the present disclosure when viewed from above. FIG. 3 is a view illustrating a cross-section taken along line I-I′ of FIG. 1. FIG. 4 is a view illustrating a cross-section taken along line II-II′ of FIG. 1.

Referring to FIGS. 1 to 4, a coil component 1000 according to an example embodiment of the present disclosure may include a body 100, a coil 300, a lead-out portion 400, and an external electrode 500, and may further include a support substrate 200.

The body 100 may form an exterior of the coil component 1000 according to this example embodiment, and the coil 300 may be buried in the body, and the support substrate 200 may be disposed therein as described below.

The body 100 may be formed in a hexahedral shape as a whole.

Based on FIG. 1, the body 100 includes a first surface 101 and a second surface 102 opposing each other in the X-direction, a third surface 103 and a fourth surface 104 opposing each other in the Y-direction, and a fifth surface 105 and a sixth surface 106 opposing each other in the Z-direction. Each of the first to fourth surfaces 101, 102, 103 and 104 of the body 100 corresponds to wall surfaces of the body 100 connecting the fifth surface 105 to the sixth surface 106 of the body 100. Hereinafter, both end surfaces of the body 100 may refer to the first surface 101 and the second surface 102 of the body, and both side surfaces of the body 100 may refer to the third surface 103 and the fourth surface 104 of the body.

Hereinafter, in the coil component 1000, a thickness direction may refer to the Z-direction (i.e., the third direction), a width direction may refer to the Y-direction (i.e., the second direction), and a length direction may refer to the X-direction (i.e., the first direction).

The body 100 may, for example, be formed so that the coil component 1000 according to an example embodiment of the present disclosure in which an external electrode 500 described below is formed has a length of 2.0 mm, a width of 1.2 mm, and a thickness of 0.65 mm, but the present disclosure is not limited to thereto.

The body 100 may include a magnetic material and a resin. Specifically, the body 100 may be formed by stacking at least one magnetic composite sheet in which a magnetic material is dispersed in the resin. However, the body 100 may have a structure other than a structure in which the magnetic material is dispersed in the resin. For example, the body 100 may be made of a magnetic material such as a ferrite.

The magnetic material may be ferrite or metal magnetic powder particles.

Examples of the ferrite powder particles may include, for example, at least one of a spinel-type ferrite such as a Mg—Zn-based ferrite, a Mn—Zn-based ferrite, a Mn—Mg-based ferrite, a Cu—Zn-based ferrite, a Mg—Mn—Sr-based ferrite and a Ni—Zn-based ferrite, a hexagonal ferrite such as a Ba—Zn-based ferrite, a Ba—Mg-based ferrite, a Ba—Ni-based ferrite, a Ba—Co-based ferrite and a Ba—Ni—Co-based ferrite, a garnet-type ferrite such as a Y-based ferrite and the like, and a Li-based ferrite.

The metal magnetic powder particles may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder, Fe—Cr-based alloy powder particles, Fe—Cr—Si-based alloy powder particles, Fe—Si—Cu—Nb-based alloy powder particles, Fe—Ni—Cr-based alloy powder particles, Fe—Cr—Al-based alloy powder particles.

The metal magnetic powder may be amorphous or crystalline. For example, the metal magnetic powder particles may be a Fe—Si—B—Cr-based amorphous alloy powder particles, but the present disclosure is not limited thereto.

Each of the ferrite and the metal magnetic powder particles may have an average diameter of about 0.1 μm to 30 μm, but the present disclosure is not limited thereto.

The body 100 may include two or more types of magnetic materials dispersed in the resin. Here, the fact that magnetic materials are of different types denotes that magnetic materials dispersed in the resin are distinguished from each other by at least one of average diameter, a composition, crystallinity, and a shape.

The resin may include epoxy, polyimide, a liquid crystal polymer, alone or in combination, but the present disclosure is not limited thereto.

The body 100 includes a core 110 penetrating through the coil 300 and the support substrate 200 described below. The core 110 may be formed by charging a through hole in which a magnetic composite sheet penetrates through the center of each of the coil 300 and the support substrate 200, but the present disclosure is not limited thereto.

The coil component 1000 according to an example embodiment of the present disclosure may further include a support substrate 200, and the support substrate 200 is buried in the body 100, and serves to support the coil 300 and the lead-out portion 400.

The support substrate 200 may be formed of an insulating material including a thermosetting insulating resin such as an epoxy resin, a thermoplastic insulating resin such as polyimide, or a photosensitive insulating resin, and the support substrate 200 may be formed of an insulating material in which a reinforcing material such as a glass fiber or an inorganic filler is impregnated in the insulating resin. For example, the support substrate 200 may be formed of an insulating material such as prepreg, an Ajinomoto Build-up Film (ABF), FR-4, a Bismaleimide Triazine (BT) resin, and photo imageable dielectric (PID), but the present disclosure is not limited thereto.

The inorganic filler may include at least one selected from the group consisting of silica (SiO₂), alumina (Al₂O₃), silicon carbide (SiC), barium sulfate (BaSO₄), talc, mud, mica powder particles, aluminum hydroxide (Al(OH)₃), and magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support substrate 200 is formed of an insulating material including a reinforcing material, the support substrate 200 may provide more excellent rigidity. When the support substrate 200 is formed of an insulating material that does not include glass fibers, the support substrate 200 may be advantageous in thinning an entire thickness of the coil component 1000 according to an example embodiment of the present disclosure. When the internal insulating layer IL is formed of an insulating material including a photosensitive insulating resin, the number of processes may be reduced, which may be advantageous in reducing production costs and may be advantageous in micro-hole processing. Furthermore, based on the body 100 having the same size, the volume occupied by the coil 300 and/or magnetic material may be increased, thereby improving component characteristics. When the support substrate 200 is formed of an insulating material including a photosensitive insulating resin, the number of processes for forming the coil 300 may be reduced, which may be advantageous in reducing production costs and may form fine vias.

The coil 300 is disposed inside the body 100 to express the characteristics of the coil component. For example, when the coil component 1000 of this example embodiment is used as a power inductor, the coil 300 may stabilize the power of the electronic device by storing an electrical field as a magnetic field and maintaining an output voltage. The coil 300 of the coil component 1000 according to an example embodiment of the present disclosure may be in the form of a planar spiral in which at least one turn is formed using the core 110 as an axis.

Since the coil 300 is connected to external electrodes 510 and 520 disposed on one end surface of the body or the other end surface of the body, as described below, through first and second lead-out portions 410 and 420, it has a surface adjacent to the end surface of the body. Here, the surface adjacent to the end surface of the body refers to a surface that is substantially parallel to one end surface and the other end surface (i.e., the first and second surfaces) opposing each other in the first direction (X-direction) of the body 100. The surface of the coil 300 adjacent to the end surface of the body is in contact with the lead-out portion 400 described below.

The coil 300 may include a lower coil 310 disposed on one surface of the support substrate 200, an upper coil 320 disposed on the other surface opposing one surface of the support substrate 200, and a via connecting the upper coil 320 to the lower coil 310.

Specifically, referring to FIG. 1 and FIG. 3, the lower coil 310 is disposed on one surface of the support substrate 200 opposing the sixth surface 106 of the body 100 and is connected to a first lead-out portion 410 described below. Referring to FIGS. 1 and 3, an upper coil 320 is disposed on the other surface of the support substrate 200 and is connected to a second lead-out portion 420 to be described below.

The via may penetrate through the support substrate 200 and connect the lower coil 310 to the upper coil 320. In this manner, the coil 300 may function as one coil.

At least one of the upper coil 320, the lower coil 310 and the via may include at least one conductive layer. That is, the coil 300 may include first conductive layers 310-1 and 320-1 in contact with the support substrate 200, and second conductive layers 310-2 and 320-2 disposed on the first conductive layers 310-1 and 320-1, respectively. For example, when the upper coil 320 and the via are formed by performing a plating treatment at an upper surface of the support substrate 200, the upper coil 320 and the via may include a seed layer and an electrolytic plating layer, respectively. Here, the electroplating layer may have a single layer structure or a multilayer structure. The electroplating layer having a multilayer structure may be formed in a conformal film structure in which another electroplating layer is formed along a surface of any electroplating layer, or may be formed in a shape in which another electroplating layer is stacked only on one surface of any electroplating layer. The seed layer may be formed by an electroless plating method or a vapor deposition method such as sputtering. The seed layer of the upper coil 320 and the seed layer of the via may not be formed integrally with each other, but the present disclosure is not limited thereto. The electroplating layer of the upper coil 320 and the electroplating layer of the via are integrally formed, so that no boundary may be formed between the electroplating layers, but the present disclosure is not limited thereto.

For another example, when the lower coil 310 disposed on the lower surface of the support substrate 200 and the upper coil 320 disposed on the upper surface of the support substrate 200 are formed separately and then stacked on the support substrate 200 all at once to form the coil 300, the via may include a high melting point metal layer and a low melting point metal layer having a melting point lower than that of the high melting point metal layer. Here, the low melting point metal layer may be formed of a solder including lead (Pb) and/or tin (Sn). At least a portion of the low melting point metal layer may be melted due to pressure and a temperature during collective stacking, and for example, an inter metallic compound layer (IMC Layer) may be formed at a boundary between the low melting point metal layer and the upper coil 320.

The lower coil 310 and the upper coil 320 may protrude from lower and upper surfaces of the support substrate 200, respectively, as illustrated in FIG. 3. For another example, the lower coil 310 may protrudes from the lower surface of the support substrate 200, and the upper coil 320 may be buried in an upper surface of the support substrate 200 so that an upper surface thereof may be exposed to the upper surface of the support substrate 200. In this case, since a concave portion is formed on the upper surface of the upper coil 320, the upper surface of the support substrate 200 and the upper surface of the upper coil 320 may not be disposed on the same plane.

Each of the lower coil 310, the upper coil 320 and the via may be formed of a conductive material such as copper (Cu), aluminum (Al), silver (Ag), tin (Sn), gold (Au), nickel (Ni), lead (Pb), titanium (Ti), chromium (Cr), or alloys thereof, but the present disclosure is not limited thereto.

A thickness of the lead-out portion 400 of the coil component 1000 according to an example embodiment of the present disclosure is thinner than a thickness of an internal coil 300. Accordingly, in order to realize a thin thickness of the coil lead-out portion 400, a structure of the lead-out portion and the coil is newly proposed.

In the case of general coil components, a lead-out portion and an internal coil grow equally by plating, and accordingly, the thickness of the lead-out portion increases, while the magnetic material covering the lead-out portion becomes relatively thin, which may easily break the lead-out portion.

Accordingly, in the case of the coil component according to an example embodiment of the present disclosure, the coil lead-out portion is formed in advance, and then a pattern for forming an internal coil is formed. Thereafter, the internal coil is formed by the plating, and the coil lead-out portion and the internal coil are connected to each other. Accordingly, when the internal coil is formed by the plating, the coil lead-out portion does not grow the plating, thereby keeping the thickness of the coil lead-out portion thin.

Lead-out portions 410 and 420 connect an end of the coil 300 to external electrodes 510 and 520, respectively, described below. The first and second lead-out portions 410 and 420 are exposed to the first and second surfaces 101 and 102 as both end surfaces of the body 100, respectively. That is, the first lead-out portion 410 is exposed to the first surface 101 of the body 100, and the second lead-out portion 420 is exposed to the second surface 102 of the body 100. The lead-out portions 410 and 420 are exposed to the end surfaces of the body 100 and are connected to the external electrodes 510 and 520 described below.

The lead-out portions 410 and 420 are derived from a substrate structure before the coil component 1000 according to an example embodiment of the present disclosure is individualized. Specifically, the substrate structure may be formed by stacking a metal layer on an insulating layer, and may be, for example, a copper foil laminate CCL. Furthermore, the substrate structure may be comprised of a multilayer metal layer by performing separate plating on a seed copper foil layer. The lead-out portions 410 and 420 may be formed by etching the metal layer of the substrate structure. Accordingly, the lead-out portions 410 and 420 may be formed of a single metal layer disposed on the support substrate 200, but the present disclosure is not limited thereto, and the lead-out portions 410 and 420 may include first metal layers 410-1 and 420-1 disposed on the support substrate 200 and the second metal layers 410-2 and 420-2 disposed on the first metal layers.

Referring to FIG. 3, lead-out portions 410 and 420 may be in contact with an end of a coil 300 in the first direction of a body 100. That is, the lead-out portions 410 and 420 are in contact with a body end surface of the coil 300, and in this case, a contact direction is a first direction of the body 100.

An interface is formed between the lead-out portions 410 and 420 and the end of the coil 300. This is because the coil 300 is formed by plating on the support substrate 200, whereas the lead-out portions 410 and 420 are formed by etching a metal layer of a substrate structure, and when the coil 300 is formed by the plating, the lead-out portions 410 and 420 are not grown by the plating. In other words, the coil 300 is grown by the plating, whereas the lead-out portion 400 is formed before the coil 300, and the lead-out portion 400 is not plated together when the coil 300 is plated, thereby forming an interface between the end of the coil 300 and the lead-out portions 410 and 420.

Specifically, the interface between the lead-out portions 410 and 420 and the end of the coil 300 is generated on a surface on which the lead-out portions 410 and 420 and surface of the coil 300 adjacent to the end surface of the body are in contact with each other. Here, the surface of the coil 300 adjacent to the end surface of the body refers to a surface substantially parallel to both end surfaces opposing each other in the first direction of the body 100 of the coil 300.

The lead-out portions 410 and 420 may include first metal layers 410-1 and 420-1 disposed on the support substrate 200 and second metal layers 410-2 and 420-2 disposed on the first metal layer. The first metal layer may form an interface with the first conductive layer of the coil 300, and the second metal layer may form an interface with the second conductive layer of the coil 300. This is because, as described above, the end of the lead-out portion 400 and the coil 300 form the interface.

The interfaces of the first metal layer and the second metal layer and the interfaces of the first plating layer and the second plating layer of the coil 300 may be discontinuous. This is because the coil 300 is grown by plating and is coupled to the lead-out portion 400 formed earlier.

FIG. 3 is a view illustrating a cross-section taken along line I-I′ of FIG. 1. Referring to FIG. 3, a thickness of an end of a coil 300 may be greater than a thickness of a lead-out portion 400, and specifically, the thickness of the end of the coil 300 may be twice or more than the thickness of the lead-out portion 400, and each thickness may be measured in the Z-direction (i.e., the third direction). That is, after the lead-out portion 400 is formed in advance, the internal coil may be formed by plating, thereby implementing the thickness of the lead-out portion 400 relatively thin.

According to one embodiment of the present disclosure, in the X-direction, thicknesses may discontinuously decrease from the end of the coil 300 to the lead-out portion 400 at a location where the end of the coil 300 meets the lead-out portion 400.

FIG. 4 is a view illustrating a cross-section taken along line II-II′ of FIG. 1. FIG. 4 illustrates a cross-section in the Y-Z-direction cut to penetrate through an end of a coil 300. Referring to FIG. 4, a width of the end of the coil 300 may be greater than a width of the lead-out portion 400, and each width may be measured in the Y-direction (i.e., the second direction). In this case, a volume of the lead-out portion 400 may be reduced, thus minimizing an area of the coil 300 exposed to cross-sections 101 and 102 of the body 100, and improving coupling force between the coil 300 and the body 100. In other words, since the lead-out portion 400 that has a smaller volume than that of the end of the coil 300 is exposed to a cross-section of the body, a contact area between the coil 300 and the body 100 increases. Accordingly, the coupling force between the coil 300 and the body 100 may be improved.

According to one embodiment of the present disclosure, in the X-direction, widths may discontinuously decrease from the end of the coil 300 to the lead-out portion 400 at a location where the end of the coil 300 meets the lead-out portion 400.

When a length and a width of the lead-out portion 400 and a thickness of the body 100 covering the lead-out portion 400 (referred to as a thickness of a cover portion) remain constant, a chipping risk the lead-out portion 400 according to the thickness of the lead-out portion 400 is illustrated in Table 1 below. The chipping risk is quantified by a composite factor, and when the chipping risk is 2.0 or less, a product is defective. The experiment was carried out under the condition in which the length and the width of the lead-out portion 400 were 0.105 μm and 0.109 μm, respectively, and the thickness of the coil 300 was 0.14 μm. In the table below, the unit of thickness is μm.

TABLE 1

| | Thickness of | Chipping risk | |
|---|---|---|---|
| Thickness of | Lead-out | (Composite | |
| Cover Portion | Portion | Factor) | Remark |
| 0.161 | 0.14 | 1.11 | Defective |
| 0.161 | 0.12 | 1.29 | Defective |
| 0.161 | 0.1 | 1.55 | Defective |
| 0.161 | 0.08 | 1.94 | Defective |
| 0.161 | 0.06 | 2.58 | Good |
| 0.161 | 0.04 | 3.88 | Good |

Referring to Table 1, it may be seen that when the thickness of the lead-out portion 400 is implemented to be less than or equal to half the thickness (0.14 μm) of the end of the coil 300, a chipping phenomenon may be prevented.

A connection structure between the coil 300 and the lead-out portion 400 may be determined by the following method. First, the coil component is polished by a depth of about ½ regardless of the direction, and a sample in which the cross-section of the lead-out portion is exposed is prepared. An internal structure of the prepared sample is confirmed through optical micrographs of an X-direction (first direction)-Z-direction (third direction) cross-section, and a Y-direction (second direction)-Z-direction (third direction) cross-section. In this case, in the case of the coil component according to an example embodiment of the present disclosure, the width and the thickness of the end of the coil are smaller than the width and the thickness of the lead-out portion, and the end of the coil and the lead-out portion are distinguishable through a plating boundary disposed therebetween.

The external electrodes 510 and 520 are disposed on a cross-section of the body 100 and are connected to the coil 300 through the lead-out portion 400. Specifically, the first external electrode 510 is disposed on a first surface 101 of the body 100 and connected to a first lead-out portion 410. The second external electrode 520 is disposed on a second surface 102 of the body 100 and connected to a second lead-out portion 420.

The external electrodes 510 and 520 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto.

Each of the external electrodes 510 and 520 may include a first electrode layer and a second electrode layer formed on the first electrode layer. That is, each of the external electrodes 510 and 520 may have a structure of a plurality of layers. Specifically, the first external electrode 510 includes a first electrode layer in contact with the first lead-out portion 410 exposed to the first surface 101 of the body 100, and a second electrode layer formed on the first electrode layer. The second external electrode 520 includes the first electrode layer in contact with the second lead-out portion 420 exposed to the second surface 102 of the body 100, and the second electrode layer formed on the first electrode layer.

The first electrode layer may be a conductive resin layer formed by curing a conductive powder including at least one of silver (Ag) and copper (Cu) and a conductive paste including an insulating resin on an external surface of the body 100. Alternatively, the first electrode layer may be, for example, a metal layer formed of copper (Cu) electrolytic plating or sputtering. When the first electrode layer is a conductive resin layer, coupling force between the external electrodes 510 and 520 and the body 100 may be improved. When the first electrode layer is a metal layer, a total thickness of the external electrodes 510 and 520 may decrease to reduce the total thickness of the components. The second electrode layer may include a nickel plating layer formed with the first electrode layer as a seed layer, and a tin plating layer disposed on the nickel plating layer.

### Modified Example of the First Example Embodiment

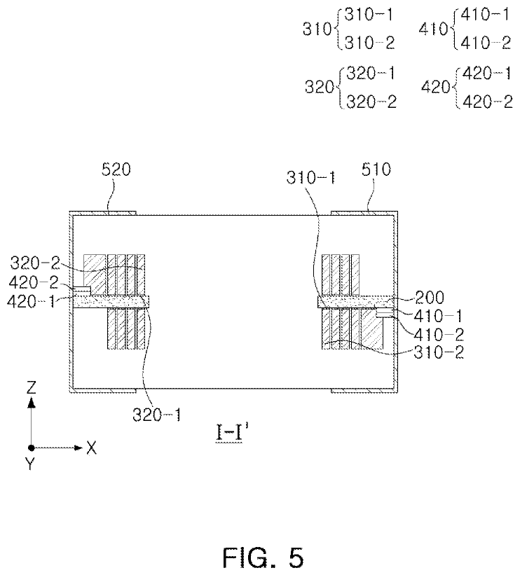

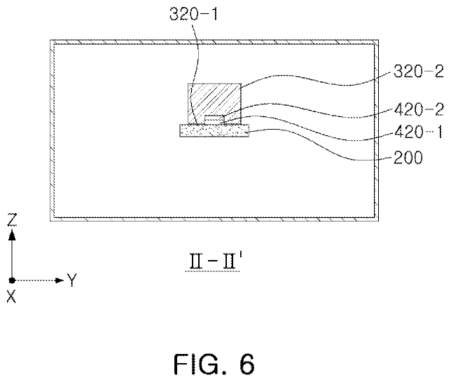

FIG. 5 is a view illustrating a cross-section taken along line I-I′ corresponding to FIG. 3 as a modified example according to an example embodiment of the present disclosure. FIG. 6 is a view illustrating a cross-section taken along line II-II′ corresponding to FIG. 4 as a modified example according to an example embodiment of the present disclosure.

Referring to FIGS. 5 and 6, a coil component 1000′ according to the modified example of the first example embodiment has a groove in an end of a coil 300 as compared to the first example embodiment. Specifically, the groove may be formed on a surface of the coil adjacent to the end surface of the body. This may be why a portion of the end of the coil 300 is formed by plating on a lead-out portion 400 as the coil 300 grows by plating. Accordingly, the lead-out portion 400 may show a structure extending to an interior of the groove of the coil 300. Comparing FIG. 4 with FIG. 6, a second lead-out portion 420 is found in FIG. 6 even though FIG. 6 is a cross-section in a Y-Z-direction cut to penetrate through the end of the coil. This is because a portion of the second lead-out portion 420 may extend to the interior of the groove of the coil 300.

That is, a portion of the lead-out portion 400 may extend to the interior of the groove of the coil 300, and a portion of the lead-out portion 400 may be buried in the coil 300. Here, the term “buried” may denote that some of the surfaces of the lead-out portion 400 are surrounded by the coil 300. However, not all of the surfaces of the lead-out portion 400 may be buried in the coil 300. Accordingly, a portion of the lead-out portion 400 may be in contact with the body 100.

Hereinafter, another description of the corresponding modified example overlaps with the description in the first example embodiment, and thus will be omitted.

Although one example embodiment of the present disclosure has been described above, it will be apparent to those skilled in the art that modifications and variations could be made in various ways by adding, changing, or deleting components within the scope of the patent claim, without departing from the scope of the present invention as defined by the appended claims, and will also be included within the scope of the present invention.

What is claimed is:

1. A coil component comprising:
a body;
a coil buried in the body;
an external electrode disposed on a first surface of the body; and
a lead-out portion connecting an end of the coil to the external electrode,
wherein the lead-out portion and the end of the coil have an interface formed therebetween.

2. The coil component according to claim 1, wherein the body includes a second surface opposing the first surface in a first direction, the end of the coil and the lead-out portion are in contact with each other in the first direction of the body.

3. The coil component according to claim 1, wherein a thickness of the end of the coil is greater than a thickness of the lead-out portion.

4. The coil component according to claim 3, wherein the thickness of the end of the coil is twice or more than the thickness of the lead-out portion.

5. The coil component according to claim 1, wherein a width of the end of the coil is greater than a width of the lead-out portion.

6. The coil component according to claim 1, further comprising:
a support substrate disposed inside the body,
wherein the coil and the lead-out portion are disposed on the support substrate.

7. The coil component according to claim 6, wherein the coil includes a first conductive layer in contact with the support substrate and a second conductive layer disposed on the first conductive layer.

8. The coil component according to claim 7, wherein the lead-out portion includes a first metal layer disposed on the support substrate and a second metal layer disposed on the first metal layer.

9. The coil component according to claim 8, wherein the first conductive layer and the first metal layer have an interface formed therebetween, and
the second conductive layer and the second metal layer have an interface formed therebetween.

10. The coil component according to claim 8, wherein an interface between the first metal layer and the second metal layer and an interface between the first conductive layer and the second conductive layer are discontinuous with each other.

11. A coil component comprising:
a body;
a coil buried in the body;
an external electrode disposed on a first surface of the body; and
a lead-out portion connecting an end of the coil to the external electrode,
wherein a groove is formed in the end of the coil, and
a portion of the lead-out portion extends to an interior of the groove.

12. The coil component according to claim 11, wherein the portion of the lead-out portion is buried in the coil.

13. The coil component according to claim 12, wherein another portion of the lead-out portion is in contact with the body.

14. The coil component according to claim 11, wherein the lead-out portion and the end of the coil have an interface formed therebetween.

15. The coil component according to claim 11, wherein in a direction in which the lead-out portion is connected to the external electrode, thicknesses discontinuously decrease from the end of the coil to the lead-out portion at a location where the end of the coil meets the lead-out portion.

16. The coil component according to claim 11, wherein in a direction in which the lead-out portion is connected to the external electrode, widths discontinuously decrease from the end of the coil to the lead-out portion at a location where the end of the coil meets the lead-out portion.
